(19) United States
(12) Patent Application Publication
(10) Pub. No.: US 2025/0005121 A1
(43) Pub. Date: Jan. 2, 2025

(54) Dynamic Identity Confidence Platform

(71) Applicant: Bank of America Corporation, Charlotte, NC (US)

(72) Inventors: Robert Cliche, New York, NY (US); Gilbert Gatchalian, Union, NJ (US); Vijaya L. Vemireddy, Plano, TX (US)

(21) Appl. No.: 18/216,027

(22) Filed: Jun. 29, 2023

(51) Int. Cl. G06F 21/31

(52) U.S. Cl. CPC G06F 21/316

(57) ABSTRACT

Arrangements for dynamic identity confidence modeling are provided. In some aspects, first identity information associated with the user may be received. An identity confidence model associated with the user indicating a level of confidence that the user is authentic may be generated. User activity data associated with transactions and interactions of the user may be received. The user activity data may include temporal information associated with the user transacting and interacting with an entity at one or more touchpoints. Second identity information associated with the user may be extracted and compared to the first identity information using machine learning. One or more anomalies may be identified and authentication information associated with the identified one or more anomalies may be requested. The identity confidence model associated with the user may be automatically and continuously updated based at least in part on the comparison.

### BACKGROUND

Aspects of the disclosure generally relate to computer systems and networks. In particular, one or more aspects of the disclosure relate to a dynamic identity confidence platform for user authentication and network security.

Unauthorized activity is a concern for enterprise organizations, customers, and users. User authentication is typically required when a user conducts a transaction or seeks access to network-based services that are protected from unauthorized users. For example, user authentication serves to validate that an individual is the individual authorized to perform certain transactions. In many instances, it may be difficult to know whether a particular user has a history of unauthorized access attempts to determine how to proceed with authenticating the user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with intelligently detecting unauthorized users and unauthorized activity.

In accordance with one or more embodiments, a computing platform having at least one processor, a communication interface, and memory may receive, from a computing device of a user, first identity information associated with the user. Based on the first identity information, the computing platform may generate an identity confidence model associated with the user. In addition, the identity confidence model may indicate a level of confidence that the user is authentic. The computing platform may receive, from the computing device of the user, user activity data associated with transactions and interactions of the user. In addition, the user activity data may include temporal information associated with the user transacting and interacting with an entity at one or more touchpoints. Responsive to receiving the user activity data, the computing platform may extract, using a machine learning model, second identity information associated with the user. The computing platform may store the first identity information and the second identity information in a database of prior identity information associated with the user. The computing platform may compare, using the machine learning model, the second identity information to the first identity information. Based on comparing the second identity information to the first identity information associated with the user, the computing platform may identify one or more anomalies and request authentication information associated with the identified one or more anomalies. The computing platform may automatically and continuously update the identity confidence model associated with the user based at least in part on the comparison.

In some embodiments, generating the identity confidence model associated with the user may include identifying one or more types of identity information, assigning a weighting to each type of identity information, and based on the assigned weighting, generating an identity confidence score.

In some example arrangements, the first identity information associated with the user may include a physical signature, a facial photo, biometric data, and/or the like.

In some embodiments, the user activity data may include geographical information associated with the transactions and interactions of the user.

In some arrangements, the temporal information may include time stamps associated with the transactions and interactions of the user.

In some examples, the computing platform may receive input data based on the user transacting or interacting with a financial institution and identify one or more anomalies based on the received input data.

In some embodiments, automatically and continuously updating the identity confidence model associated with the user may include increasing or decreasing the level of confidence that a user identity is authentic by a predetermined value.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for dynamic identity confidence modeling in accordance with one or more arrangements discussed herein;

FIGS. 2A-2D depict an illustrative event sequence for dynamic identity confidence modeling in accordance with one or more arrangements discussed herein;

FIGS. 3 and 4 depict example graphical user interfaces for dynamic identity confidence modeling in accordance with one or more arrangements discussed herein; and

FIG. 5 depicts an illustrative method for dynamic identity confidence modeling in accordance with one or more arrangements discussed herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to dynamic identity confidence modeling. In particular, one or more aspects of the disclosure may identify potential malicious actors via dynamic identity confidence models or user profiles. Additional aspects of the disclosure provide a holistic approach to user authentication by creating identity confidence profiles (e.g., trust profiles) that may be dynamic based on user transactions and interactions across various touchpoints. For example, systems could receive time-stamped user data and interactions data to build an identity confidence profile for a user, and as the user interacts with various touchpoints, the identity confidence profile may be updated. These and various other arrangements will be discussed more fully below.

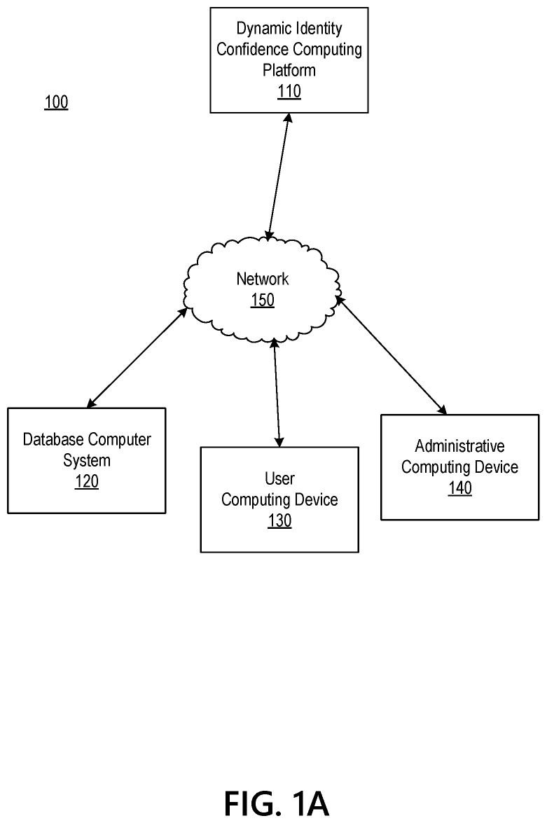

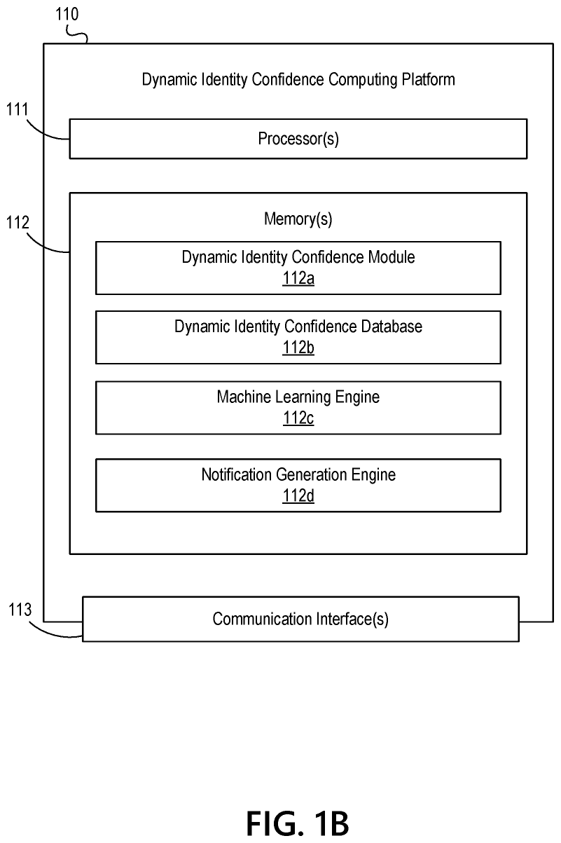

Aspects described herein may be implemented using one or more computing devices operating in a computing environment. For instance, FIGS. 1A and 1B depict an illustrative computing environment for dynamic identity confidence modeling in accordance with one or more example arrangements. Referring to FIG. 1A, computing environment 100 may include one or more computing devices and/or other computing systems. For example, computing environment 100 may include dynamic identity confidence computing platform 110, database computer system 120, user computing device 130, and administrative computing device 140. In some examples, computing environment 100 may be a distributed computing environment such as a cloud computing environment. Although one database computer system 120, one user computing device 130, and one administrative computing device 140 are shown, any number of devices or data sources may be used without departing from the disclosure.

As described further below, dynamic identity confidence computing platform 110 may include one or more computing devices configured to perform one or more of the functions described herein. For example, dynamic identity confidence computing platform 110 may include one or more computer systems, servers, server blades, or the like. In one or more instances, dynamic identity confidence computing platform 110 may be configured to host and/or otherwise maintain one or more machine learning models that may be used in performing dynamic identity confidence modeling and/or one or more other functions described herein. Among other functions, dynamic identity confidence computing platform 110 may monitor user activity data to detect potential unauthorized users based on transactions and interactions of a user. In some instances, dynamic identity confidence computing platform 110 may be configured to dynamically tune machine learning models and/or algorithms as additional data is received, detected, or analyzed.

Database computer system 120 may include different information storage entities storing identity information associated with the user (e.g., a physical signature, a facial photo, biometric data, personally identifiable information, user account information, unique user identifier, and/or the like) and user activity data associated with the user (e.g., temporal information associated with the user transacting and interacting with an entity at one or more touchpoints, or the like). In some examples, database computer system 120 may store one or more user identity confidence models for identifying an authenticity or identity of a user (e.g., indicating a level of confidence that the user is actually who they say they are). Additionally or alternatively, the one or more user identity confidence models may evolve or change with time (e.g., as a user transacts or interacts with an entity at one or more touchpoints). In some examples database computer system 120 may store public (e.g., external) data and private (e.g., internal) data.

User computing device 130 may be or include one or more computing devices and/or other computer components (e.g., processors, memories, communication interfaces). For example, user computing device 130 may be a desktop computing device (e.g., desktop computer, terminal), or the like or a mobile computing device (e.g., telephone, smartphone, tablet, smart watch, laptop computer, or the like) used by users interacting with dynamic identity confidence computing platform 110.

Administrative computing device 140 may be or include one or more computing devices and/or other computer components (e.g., processors, memories, communication interfaces). For instance, administrative computing device 140 may be a server, desktop computer, laptop computer, tablet, mobile device, or the like, and may be used by an information security officer, administrative user, or the like. In addition, administrative computing device 140 may be associated with an enterprise organization operating dynamic identity confidence computing platform 110. In some examples, administrative computing device 140 may be used to configure, control, and/or otherwise interact with dynamic identity confidence computing platform 110, and/or one or more other devices and/or systems included in computing environment 100.

Computing environment 100 also may include one or more networks, which may interconnect one or more of dynamic identity confidence computing platform 110, database computer system 120, user computing device 130, and administrative computing device 140. For example, computing environment 100 may include a network 150 (which may, e.g., interconnect dynamic identity confidence computing platform 110, database computer system 120, user computing device 130, administrative computing device 140, and/or one or more other systems which may be associated with an enterprise organization, such as a financial institution, with one or more other systems, public networks, sub-networks, and/or the like).

In one or more arrangements, dynamic identity confidence computing platform 110, database computer system 120, user computing device 130, and administrative computing device 140 may be any type of computing device capable of dynamic identity confidence modeling for identifying potential unauthorized users and unauthorized activity. For example, dynamic identity confidence computing platform 110, database computer system 120, user computing device 130, administrative computing device 140, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions as described herein.

Referring to FIG. 1B, dynamic identity confidence computing platform 110 may include one or more processors 111, memory 112, and communication interface 113. A data bus may interconnect processor(s) 111, memory 112, and communication interface 113. Communication interface 113 may be a network interface configured to support communication between dynamic identity confidence computing platform 110 and one or more networks (e.g., network 150, or the like). Memory 112 may include one or more program modules having instructions that when executed by processor(s) 111 cause dynamic identity confidence computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of dynamic identity confidence computing platform 110 and/or by different computing devices that may form and/or otherwise make up dynamic identity confidence computing platform 110.

For example, memory 112 may have, store and/or include a dynamic identity confidence module 112a, a dynamic identity confidence database 112b, a machine learning engine 112c, and a notification generation engine 112d. Dynamic identity confidence module 112a, may have instructions that direct and/or cause dynamic identity confidence computing platform 110 to, for instance, learn to identify potential unauthorized users using dynamic identity confidence modeling and determine when to trigger additional authentication requirements, and/or instructions that direct dynamic identity confidence computing platform 110 to perform other functions, as discussed in greater detail below. Dynamic identity confidence database 112b may store information used by dynamic identity confidence module 112a and/or dynamic identity confidence computing platform 110 in performing dynamic identity confidence modeling, and/or in performing other functions, as discussed in greater detail below.

Dynamic identity confidence computing platform 110 may further have, store and/or include a machine learning engine 112c. Machine learning engine 112c may use artificial intelligence/machine learning (AI/ML) algorithms to derive rules and identify patterns and anomalies associated with received data/input. In some examples, the AI/ML algorithm may include natural language processing (NLP), abstract syntax trees (ASTs), clustering, and/or the like. Machine learning engine 112c may have instructions that direct and/or cause dynamic identity confidence computing platform 110 to set, define, and/or iteratively redefine rules, techniques and/or other parameters used by dynamic identity confidence computing platform 110 and/or other systems in computing environment 100 in identifying potential unauthorized users, for example, unauthorized users having a history of unauthorized activity attempts and triggering additional authentication requirements when appropriate. In some examples, dynamic identity confidence computing platform 110 may build and/or train one or more machine learning models. For example, memory 112 may have, store, and/or include historical/training data. In some examples, dynamic identity confidence computing platform 110 may receive historical and/or training data and use that data to train one or more machine learning models stored in machine learning engine 112c. The historical and/or training data may include, for instance, historical interaction data, historical transaction data, historical banking data, historical identity record data, and/or the like. The data may be gathered and used to build and train one or more machine learning models executed by machine learning engine 112c to identify unauthorized users based on one or more occurrences of potential unauthorized activity, including determining whether the user/data should be flagged for investigation (e.g., for potential anomalous or unauthorized activity), and/or perform other functions, as discussed in greater detail below. Various machine learning algorithms may be used without departing from the disclosure, such as supervised learning algorithms, unsupervised learning algorithms, abstract syntax tree algorithms, natural language processing algorithms, clustering algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, artificial neural network algorithms, and the like. Additional or alternative machine learning algorithms may be used without departing from the disclosure.

Dynamic identity confidence computing platform 110 may further have, store and/or include a notification generation engine 112d. Notification generation engine 112d may store instructions and/or data that may cause or enable dynamic identity confidence computing platform 110 to send, to another computing device (e.g., administrative computing device 140), notifications or results related to detection of a potential unauthorized user.

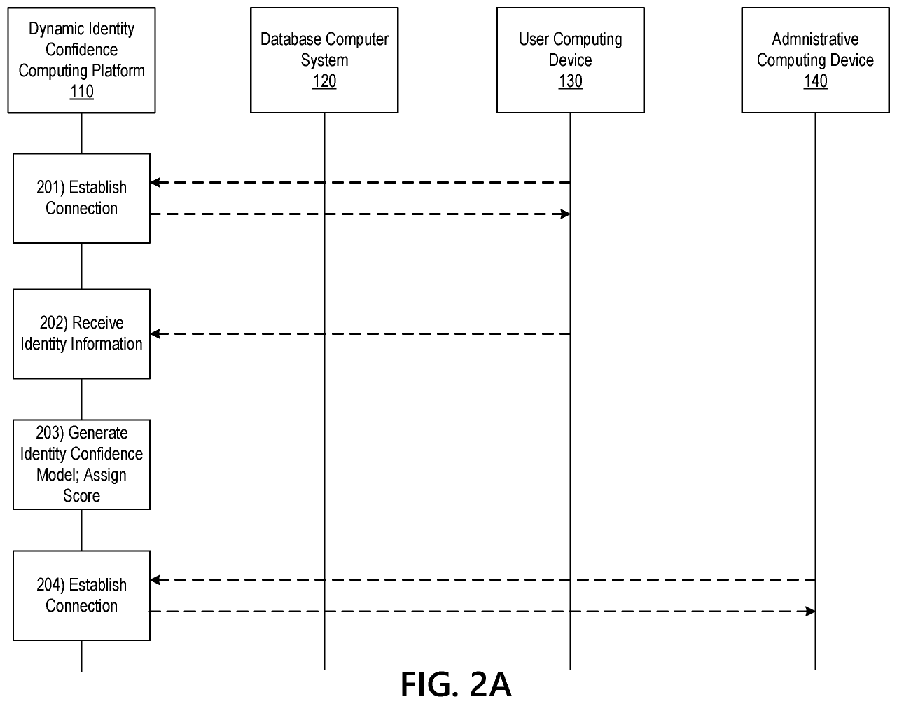

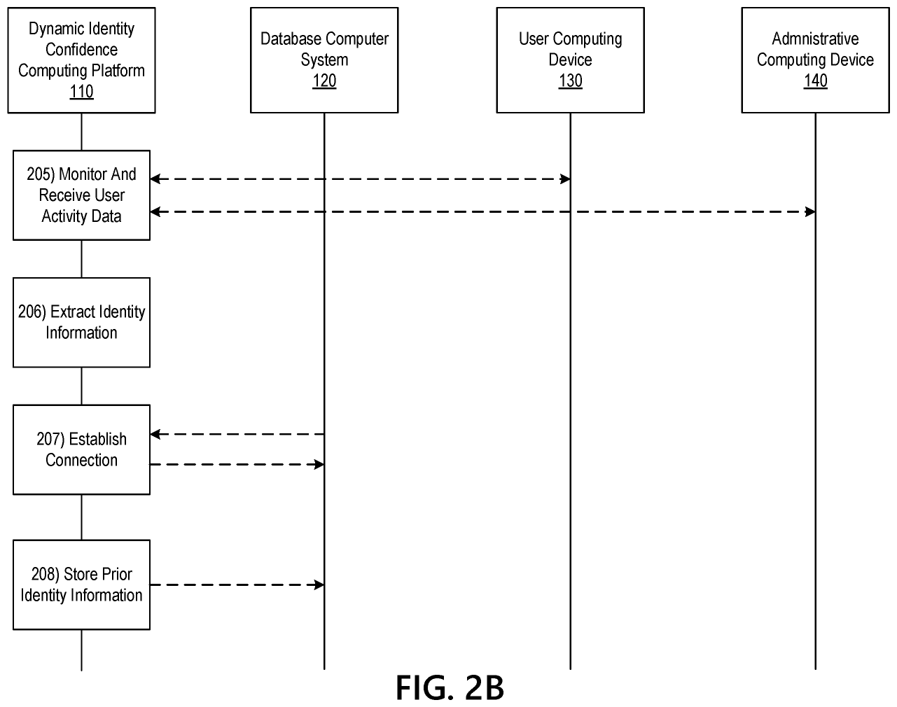

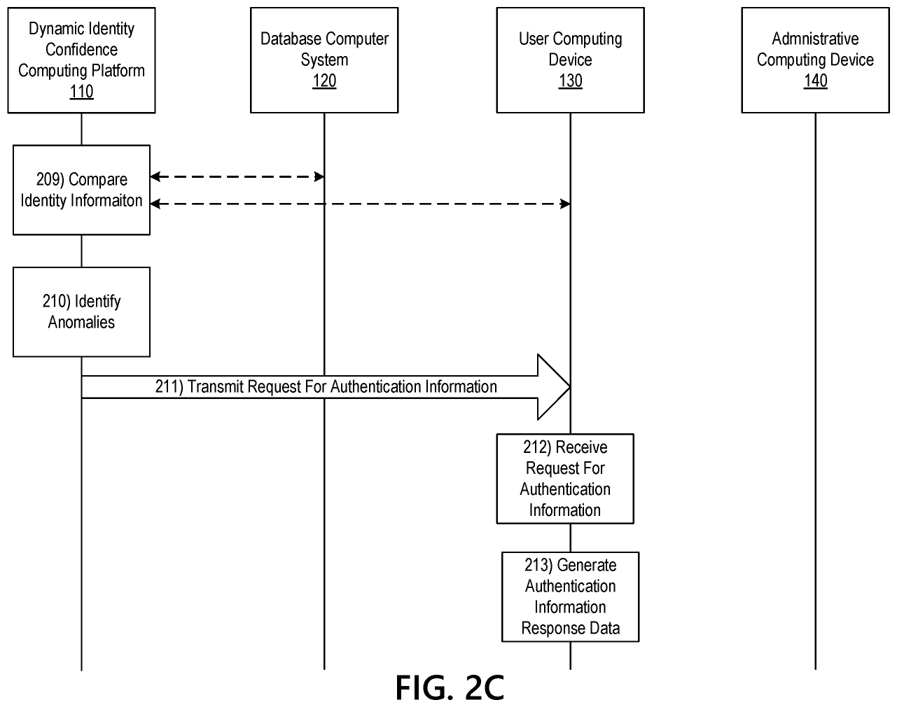

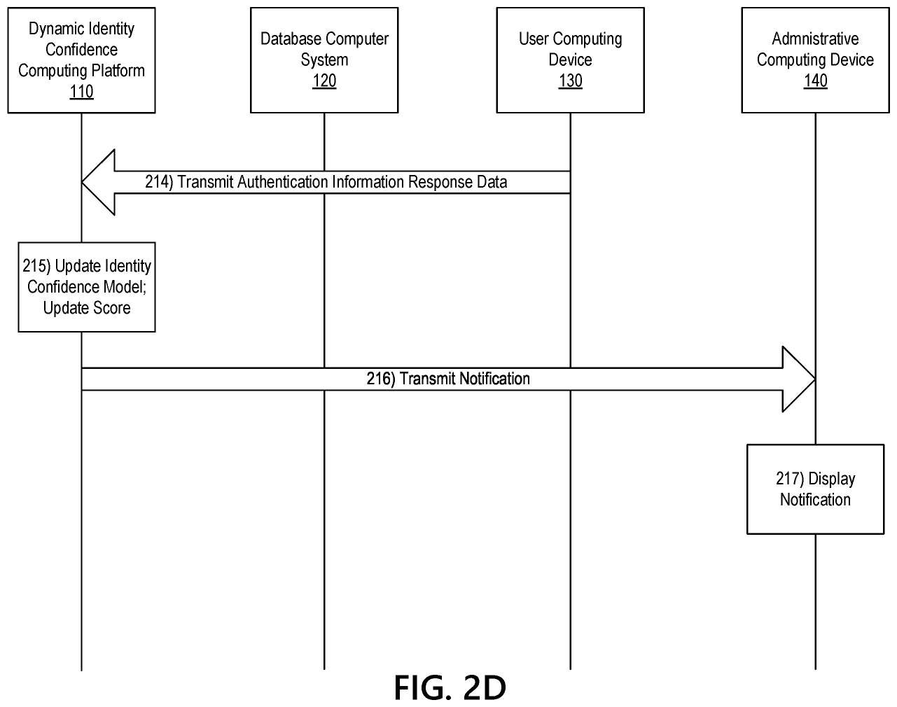

FIGS. 2A-2D depict one example illustrative event sequence for dynamic identity confidence modeling in accordance with one or more aspects described herein. The events shown in the illustrative event sequence are merely one example sequence and additional events may be added, or events may be omitted, without departing from the disclosure. Further, one or more processes discussed with respect to FIGS. 2A-2D may be performed in real-time or near real-time.

With reference to FIG. 2A, at step 201, dynamic identity confidence computing platform 110 may connect to user computing device 130. For instance, a first wireless connection may be established between dynamic identity confidence computing platform 110 and user computing device 130. Upon establishing the first wireless connection, a communication session may be initiated between dynamic identity confidence computing platform 110 and user computing device 130.

At step 202, dynamic identity confidence computing platform 110 may receive, via a communication interface (e.g., communication interface 113), from a computing device of a user (e.g., user computing device 130), first identity information associated with the user. In some examples, the first identity information associated with the user may include a physical signature, a facial photo, biometric data, personally identifiable information, user account information, unique user identifier, and/or the like.

At step 203, based on the first identity information, dynamic identity confidence computing platform 110 may generate an identity confidence model associated with the user. In addition, the identity confidence model may indicate a level of confidence that the user is authentic. Additionally or alternatively, the identity model may evolve or change with time (e.g., as users transact and interact with an entity at one or more touch points). For instance, a new user may begin at a low identity confidence rating based on, for instance, opening an account with a physical signature, a facial photo, or the like, and continue to build trust over time.

In generating the identity confidence model associated with the user, dynamic identity confidence computing platform 110 may identify one or more types of identity information, and assign a weighting to each type of identity information. For instance, information identifying a social security number of an individual may be weighted higher than information identifying a street address of the individual. Based on the assigned weighting, dynamic identity confidence computing platform 110 may generate and assign an identity confidence score/level or an identity confidence profile associated with the user using the machine learning model. For example, the identity confidence score may detect a potential unauthorized user or potential unauthorized activity. For instance, the identity confidence score/level may be a score between zero to one hundred, where a low score may indicate a low level of confidence that the user is authentic (e.g., or high risk of potential unauthorized activity), while a high score may indicate a high level of confidence that the user is authentic (e.g., or low risk of potential unauthorized activity). In some examples, dynamic identity confidence computing platform 110 may retrieve or determine a predetermined threshold, compare the identity confidence score to the predetermined threshold, and based on the comparison, determine an occurrence of unauthorized activity associated with the entity when the identity confidence score is above (e.g., greater than) or equal to the predetermined threshold. In some examples, the predetermined threshold may be set by an administrative user, as a default or adjustable variable.

At step 204, dynamic identity confidence computing platform 110 may connect to administrative computing device 140. For instance, a second wireless connection may be established between dynamic identity confidence computing platform 110 and administrative computing device 140. Upon establishing the second wireless connection, a communication session may be initiated between dynamic identity confidence computing platform 110 and administrative computing device 140.

Referring to FIG. 2B, at step 205, dynamic identity confidence computing platform 110 may monitor and receive (with user's permission), via the communication interface (e.g., communication interface 113), user activity data associated with transactions and interactions of the user. In some examples, the user activity may include geographical information associated with the transactions and interactions of the user. In some examples, the user activity data may include temporal information associated with the user transacting and interacting with an entity at one or more touchpoints (e.g., via telephone, internet, or direct contact with an individual). In addition, the temporal information may include time stamps associated with the transactions and interactions of the user.

In some embodiments, dynamic identity confidence computing platform 110 may monitor and receive (with user's permission) the user activity data from the computing device of the user (e.g., user computing device 130). Additionally or alternatively, dynamic identity confidence computing platform 110 may monitor and receive (with user's permission) the user activity data from an administrative computing device (e.g., administrative computing device 140). In some examples, dynamic identity confidence computing platform 110 may receive input data (e.g., from administrative computing device 140) based on the user transacting or interacting with a financial institution. For instance, a financial institution associate may input data to a user's identity confidence profile based on transactions and interactions with the user, and this information may be used in a later verification process and/or to detect outlier data, as discussed more fully herein.

In some embodiments, dynamic identity confidence computing platform 110 may establish an opt-in procedure by which users may consent or authorize the system to access and retrieve user activity data, user identification information, or the like. In some examples, users may be offered incentives to encourage participation in efforts to prevent unauthorized activity. Additionally, dynamic identity confidence computing platform 110 may establish an opt-out procedure by which users can request that their activity data or identity information is not accessed by the system.

At step 206, responsive to receiving the user activity data, dynamic identity confidence computing platform 110 may extract, using a machine learning model (e.g., via machine learning engine 112c), second identity information associated with the user. For instance, dynamic identity confidence computing platform 110 may use a parser to extract identity information from the received user activity data.

At step 207, database computer system 120 may connect to dynamic identity confidence computing platform 110. For instance, a third wireless connection may be established between database computer system 120 and dynamic identity confidence computing platform 110. Upon establishing the third wireless connection, a communication session may be initiated between database computer system 120 and dynamic identity confidence computing platform 110.

At step 208, dynamic identity confidence computing platform 110 may store the first identity information and the second identity information in a database (e.g., database computer system 120) of prior identity information associated with the user (e.g., for later comparison). For example, referring to FIG. 2C, at step 209, dynamic identity confidence computing platform 110 may compare, using the machine learning model (e.g., via machine learning engine 112c), the second identity information to the first identity information.

In some embodiments, at step 210, based on comparing the second identity information to the first identity information associated with the user, dynamic identity confidence computing platform 110 may identify one or more anomalies (e.g., outlier behaviors/data) and request authentication information (e.g., from user computing device 130) associated with the identified one or more anomalies (e.g., identified outliers).

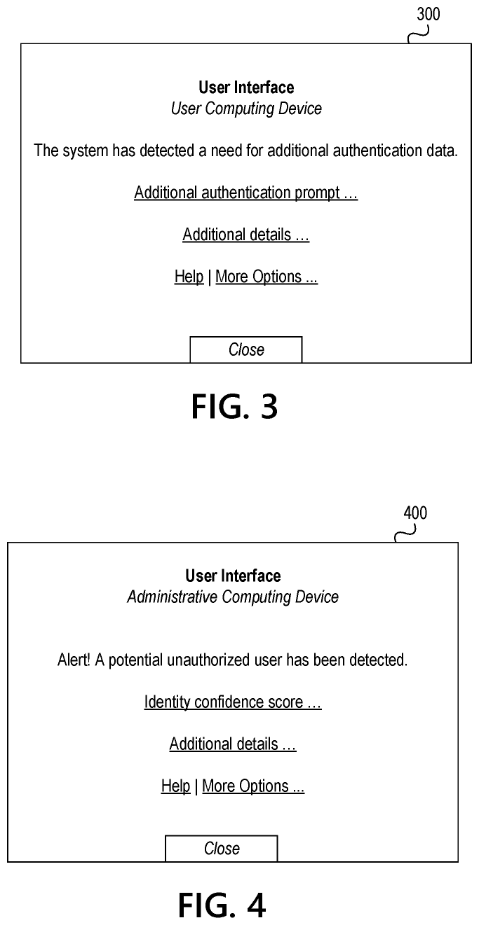

At step 211, dynamic identity confidence computing platform 110 may transmit a request, to the computing device of the user (e.g., user computing device 130), for the authentication information. In some aspects, transmitting the request to the user to provide authentication information may include prompting the user for authentication information associated with the identified one or more anomalies to confirm user authenticity. For example, the computing device of the user (e.g., user computing device 130) may display and/or otherwise present one or more graphical user interfaces similar to graphical user interface 300, which is illustrated in FIG. 3. As shown in FIG. 3, graphical user interface 300 may include text and/or other information associated with additional authentication requirements (e.g., “The system has detected a need for additional authentication data. [Additional authentication prompt . . . ] [Additional details . . . ]”). It will be appreciated that other and/or different notifications may also be provided.

Returning to FIG. 2C, at step 212, the computing device of the user (e.g., user computing device 130) may receive and display the request for the authentication information. In response, at step 213, authentication information response data may be generated. Referring to FIG. 2D, at step 214, the computing device of the user (e.g., user computing device 130) may transmit the authentication information response data to dynamic identity confidence computing platform 110.

At step 215, based on receiving the authentication information response data, dynamic identity confidence computing platform 110 may automatically and continuously update the identity confidence model associated with the user. For example, dynamic identity confidence computing platform 110 may automatically and continuously update the identity confidence model based at least in part on comparison of the identity information (e.g., at step 209, comparing the second identity information to the first identity information) and the identified anomalies (e.g., at step 210).

In some examples, dynamic identity confidence computing platform 110 may automatically and continuously update the identity confidence model associated with the user by adjusting the identity confidence score based on the user activity data. For instance, dynamic identity confidence computing platform 110 may increase or decrease the level of confidence that a user identity is authentic by a predetermined value, thereby continuously improving the accuracy of predictions relating to authentication of the user. For example, dynamic identity confidence computing platform 110 may increase a user's identity confidence score based on a positive identity transaction/interaction (e.g., successful identification check or non-fraudulent transaction), and decrease a user's identity confidence score based on a negative identity transaction/interaction (e.g., failed identification check or fraudulent transaction). In another example, verifiable interactions (e.g., transactions that can be linked back to the involved parties) may be used to increase the confidence profile of the user.

At step 216, dynamic identity confidence computing platform 110 may transmit (e.g., via notification generation engine 112d), via the communication interface (e.g., communication interface 113), one or more notifications or alerts (e.g., to administrative computing device 140). For instance, the administrative computing device (e.g., administrative computing device 140) may display and/or otherwise present one or more graphical user interfaces similar to graphical user interface 400, which is illustrated in FIG. 4. As shown in FIG. 4, graphical user interface 400 may include text and/or other information associated with an alert or notification (e.g., “Alert! A potential unauthorized user has been detected. [Identity confidence score . . . ] [Additional details . . . ]”). It will be appreciated that other and/or different notifications may also be provided. Returning to FIG. 2D, at step 217, the administrative computing device (e.g., administrative computing device 140) may receive and display the notification or alert (e.g., security notification). It will be appreciated that other and/or different notifications may also be provided.

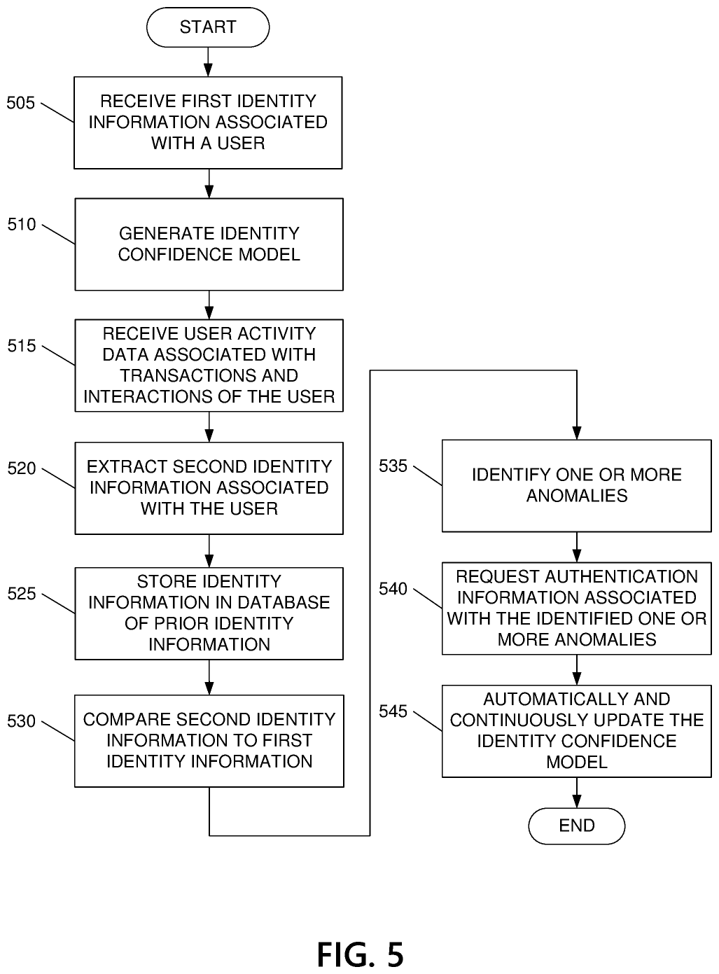

FIG. 5 depicts an illustrative method for dynamic identity confidence modeling in accordance with one or more example embodiments. With reference to FIG. 5, at step 505, a computing platform having at least one processor, a communication interface, and memory may receive, from a computing device of a user, first identity information associated with the user. At step 510, based on the first identity information, the computing platform may generate an identity confidence model associated with the user. In addition, the identity confidence model may indicate a level of confidence that the user is authentic. At step 515, the computing platform may receive, from the computing device of the user, user activity data associated with transactions and interactions of the user. In addition, the user activity data may include temporal information associated with the user transacting and interacting with an entity at one or more touchpoints. At step 520, responsive to receiving the user activity data, the computing platform may extract, using a machine learning model, second identity information associated with the user. At step 525, the computing platform may store the first identity information and the second identity information in a database of prior identity information associated with the user. At step 530, the computing platform may compare, using the machine learning model, the second identity information to the first identity information. At step 535, based on comparing the second identity information to the first identity information associated with the user, the computing platform may identify one or more anomalies. At step 540, the computing platform may request authentication information associated with the identified one or more anomalies. At step 545, the computing platform may automatically and continuously update the identity confidence model associated with the user based at least in part on the comparison.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, from a computing device of a user, first identity information associated with the user;
based on the first identity information, generate an identity confidence model associated with the user, wherein the identity confidence model indicates a level of confidence that the user is authentic;
receive, from the computing device of the user, user activity data associated with transactions and interactions of the user, wherein the user activity data comprises temporal information associated with the user transacting and interacting with an entity at one or more touchpoints;
responsive to receiving the user activity data, extract, using a machine learning model, second identity information associated with the user;
store the first identity information and the second identity information in a database of prior identity information associated with the user;
compare, using the machine learning model, the second identity information to the first identity information;
based on comparing the second identity information to the first identity information associated with the user, identify one or more anomalies;
request authentication information associated with the identified one or more anomalies; and
automatically and continuously update the identity confidence model associated with the user based at least in part on the comparison.

2. The computing platform of claim 1, wherein generating the identity confidence model associated with the user comprises:
identifying one or more types of identity information;
assigning a weighting to each type of identity information; and
based on the assigned weighting, generating an identity confidence score.

3. The computing platform of claim 1, wherein the first identity information associated with the user comprises one or more of: a physical signature, a facial photo, or biometric data.

4. The computing platform of claim 1, wherein the user activity data comprises geographical information associated with the transactions and interactions of the user.

5. The computing platform of claim 1, wherein the temporal information comprises time stamps associated with the transactions and interactions of the user.

6. The computing platform of claim 1, further including instructions that, when executed, cause the computing platform to:
receive input data based on the user transacting or interacting with a financial institution; and
identify one or more anomalies based on the received input data.

7. The computing platform of claim 1, wherein automatically and continuously updating the identity confidence model associated with the user comprises increasing or decreasing the level of confidence that a user identity is authentic by a predetermined value.

8. A method, comprising:
at a computing platform comprising at least one processor, a communication interface, and memory:
receiving, by the at least one processor, from a computing device of a user, first identity information associated with the user;
based on the first identity information, generating, by the at least one processor, an identity confidence model associated with the user, wherein the identity confidence model indicates a level of confidence that the user is authentic;
receiving, by the at least one processor, from the computing device of the user, user activity data associated with transactions and interactions of the user, wherein the user activity data comprises temporal information associated with the user transacting and interacting with an entity at one or more touchpoints;
responsive to receiving the user activity data, extracting, by the at least one processor, using a machine learning model, second identity information associated with the user;
storing, by the at least one processor, the first identity information and the second identity information in a database of prior identity information associated with the user;
comparing, by the at least one processor, using the machine learning model, the second identity information to the first identity information;
based on comparing the second identity information to the first identity information associated with the user, identifying, by the at least one processor, one or more anomalies;
requesting, by the at least one processor, authentication information associated with the identified one or more anomalies; and
automatically and continuously updating, by the at least one processor, the identity confidence model associated with the user based at least in part on the comparison.

9. The method of claim 8, further comprising:
identifying, by the at least one processor, one or more types of identity information;
assigning, by the at least one processor, a weighting to each type of identity information; and
based on the assigned weighting, generating, by the at least one processor, an identity confidence score.

10. The method of claim 8, wherein the first identity information associated with the user comprises one or more of: a physical signature, a facial photo, or biometric data.

11. The method of claim 8, wherein the user activity data comprises geographical information associated with the transactions and interactions of the user.

12. The method of claim 8, wherein the temporal information comprises time stamps associated with the transactions and interactions of the user.

13. The method of claim 8, further comprising:
receiving, by the at least one processor, input data based on the user transacting or interacting with a financial institution; and
identifying, by the at least one processor, one or more anomalies based on the received input data.

14. The method of claim 8, wherein automatically and continuously updating the identity confidence model associated with the user comprises increasing or decreasing the level of confidence that a user identity is authentic by a predetermined value.

15. One or more non-transitory computer-readable media storing instructions that, when executed by a computing platform comprising at least one processor, memory, and a communication interface, cause the computing platform to:
receive, from a computing device of a user, first identity information associated with the user;
based on the first identity information, generate an identity confidence model associated with the user, wherein the identity confidence model indicates a level of confidence that the user is authentic;
receive, from the computing device of the user, user activity data associated with transactions and interactions of the user, wherein the user activity data comprises temporal information associated with the user transacting and interacting with an entity at one or more touchpoints;
responsive to receiving the user activity data, extract, using a machine learning model, second identity information associated with the user;
store the first identity information and the second identity information in a database of prior identity information associated with the user;
compare, using the machine learning model, the second identity information to the first identity information;
based on comparing the second identity information to the first identity information associated with the user, identify one or more anomalies;
request authentication information associated with the identified one or more anomalies; and
automatically and continuously update the identity confidence model associated with the user based at least in part on the comparison.

16. The one or more non-transitory computer-readable media of claim 15, wherein the instructions, when executed by the computing platform, further cause the computing platform to:
based on comparing the second identity information to the first identity information associated with the user, identify one or more anomalies; and
request authentication information associated with the identified one or more anomalies.

17. The one or more non-transitory computer-readable media of claim 15, wherein generating the identity confidence model associated with the user comprises:
identifying one or more types of identity information;
assigning a weighting to each type of identity information; and
based on the assigned weighting, generating an identity confidence score.

18. The one or more non-transitory computer-readable media of claim 15, wherein the temporal information comprises time stamps associated with the transactions and interactions of the user.

19. The one or more non-transitory computer-readable media of claim 15, wherein the instructions, when executed by the computing platform, further cause the computing platform to:
receive input data based on the user transacting or interacting with a financial institution; and
identify one or more anomalies based on the received input data.

20. The one or more non-transitory computer-readable media of claim 15, wherein automatically and continuously updating the identity confidence model associated with the user comprises increasing or decreasing the level of confidence that a user identity is authentic by a predetermined value.
